(19) United States
(12) Patent Application Publication
(10) Pub. No.: US 2022/0343237 A1
(43) Pub. Date: Oct. 27, 2022

(54) Method for Providing Information Related to Item Scrap and an Apparatus for the Same

(71) Applicant: Coupang Corp., Seoul (KR)

(72) Inventors: Wei Wei, Seoul (KR); Zonghan Wu, Seoul (KR); Ping Yin, Seoul (KR); Soo Kyung Choi, Seoul (KR); Timothy Wolfgang Schoenharl, Seoul (KR)

(73) Assignee: Coupang Corp., Seoul (KR)

(21) Appl. No.: 17/466,193

(22) Filed: Sep. 3, 2021

(30) Foreign Application Priority Data
Apr. 23, 2021 (KR) 10-2021-0052835

(51) Int. Cl. G06Q 10/06; G06Q 10/08; G06Q 30/02; G06N 5/00

(52) U.S. Cl. CPC G06Q 10/0637; G06Q 10/087; G06Q 30/0201; G06N 5/003

(57) ABSTRACT

Provided is a method of providing information related to item scrap, the method including at least one of confirming information on an item scrapped in a fulfillment center, confirming a cause of scrapping the item based on the information on the item including a code life of the item and an average sales amount of the item, and providing information indicating the cause of scrapping the item.

### RELATED APPLICATION INFORMATION

The present application claims priority to and the benefit of Korean Patent Application No. 10-2021-0052835 filed on Apr. 23, 2021, and is incorporated by reference herein in its entirety.

### TECHNICAL FIELD

Various example embodiments of the present disclosure relate to a method of providing information related to item scrap and an apparatus for providing the same, and more particularly, to a method of analyzing a cause of scrapping an item for each item or for each item unit by using information on the item and providing information indicating a measure to prevent the scrap, and an apparatus for providing the same.

### DESCRIPTION OF THE RELATED ART

With the development of electronic technology, e-commerce has taken its place as a form of shopping. Customers may purchase items online without going to shopping malls or markets directly, and the items purchased online are delivered to delivery destinations requested by the customers.

A logistics information management system for e-commerce services as described above may operate a plurality of fulfillment centers in order to provide more effective services and may manage information on each fulfillment center. For example, when an order for an item is requested, the logistics information management system determines fulfillment centers to process the orders in consideration of characteristics of the order (for example, delivery destination, stock of fulfillment centers, or the like) and may assign orders to the determined fulfillment centers.

For reference, related art documents such as KR100932262B1 may be referred to.

### DISCLOSURE OF THE INVENTION

### Technical Goals

An aspect is to accurately analyze a cause of scrapping an item when the item scrap occurs and provide information indicating a necessary measure to prevent the item from being scrapped in the future.

The technical goals to be achieved by the example embodiments of the present disclosure are not limited to the technical goals as described above, and other technical goals may be inferred from the following example embodiments.

### Technical Solutions

According to an aspect, there is provided a method of providing information including: confirming information on an item scrapped in a fulfillment center; confirming a cause of scrapping the item based on the information on the item including a code life of the item and an average sales amount of the item; and providing information indicating the cause of scrapping the item.

The cause of scrapping the item may include at least one of a first scrap cause related to a minimum order quantity of the item, a second scrap cause related to the fulfillment center, a third scrap cause related to a sales status of the item, a fourth scrap cause related to a shipment status of the item, a fifth scrap cause based on a forecast error of a sales amount of the item, and a sixth scrap cause based on over ordering of the item.

The confirming of the cause of scrapping the item may include confirming the cause of scrapping the item in an order of confirming a scrap cause determined based on a priority of the first scrap cause to the sixth scrap cause.

The information on the item may further include a minimum order quantity corresponding to the item, and furthermore, the confirming of the scrap cause may include determining the cause of scrapping the item as the first scrap cause when the minimum order quantity is greater than a product of the code life of the item and the average sales amount of the item for the code life.

The method may further include: when the cause of scrapping the item is the first scrap cause, confirming a first average sales amount of the item for a first period and a second average sales amount indicating the average sales amount of the item for a second period next to the first period based on the average sales amount of the item; and calculating an appropriate minimum order quantity corresponding to the item based on the first average sales amount and the second average sales amount when the second average sales amount is smaller than or equal to the first average sales amount.

When the second average sales amount is greater than the first average sales amount, an exposure priority of the item may increase.

When the second average sales amount is greater than the first average sales amount, the item may be exposed on a main page.

The second scrap cause may include a first scrap sub-cause related to a receiving delay of the item, a second scrap sub-cause related to a stowing delay of the item, and a third scrap sub-cause related to loss of the item.

The information on the item may include a unloading completion time of the item in the fulfillment center, a scheduled receiving time of the item, an unloading amount of the item, and a confirmed quantity of the item, and the method of providing information may further include determining the cause of scrapping the item as the first scrap sub-cause of the second scrap cause when the unloading amount of the item is greater than or equal to a specific percentage of the confirmed quantity and a difference between the unloading completion time of the item and the scheduled receiving time of the item is a specific time or more.

The information on the item may include the unloading amount of the item and the stowing quantity of the item in the fulfillment center, and the method of providing information may further include determining the cause of scrapping the item as the second scrap sub-cause when the unloading amount of the item is greater than the stowing quantity of the item and a difference between a stowing completion time of the item and the unloading completion time of the item is the specific time or more.

When a difference between a time when the item is scrapped and a time when the scrapped item is received is the specific time or more, the determining of the scrap cause may include determining the cause of scrapping the item as a third scrap sub-cause.

The information on the item may include a first maximum sales amount indicating a maximum sales amount among daily sales amounts of the item for the first period, a second maximum sales amount indicating a maximum sales amount among daily sales amounts of the item for the second period next to the first period, a first average sales amount indicating an average sales amount of the item for the first period, and a second average sales amount indicating an average sales amount of the item for the second period, and the determining of the scrap cause may further include determining the cause of scrapping the item as the fifth scrap cause when the second maximum sales amount is smaller than or equal to a specific percentage of the first maximum sales amount and the second average sales amount is smaller than or equal to a specific percentage of the first average sales amount.

The determining of the scrap cause may further include: confirming an order quantity of the item, and determining the cause of scrapping the item as the sixth scrap cause when the order quantity is greater than a product of the code life and the average sales amount of the item for the code life.

The order quantity may be determined based on a value obtained by subtracting a maximum value of a forecasted scrap quantity of the item and a minimum cost for the item within a specific period from a sum of a forecasted receiving quantity of the item and a safety stock quantity of the item within the specific period.

The method may further include reducing the safety stock quantity of the item based on the code life and the average sales amount when the cause of scrapping the item is the sixth scrap cause, the method of providing information.

The confirming of the cause of scrapping the item may include confirming the cause of scrapping the item based on a decision tree for determining the scrap cause based on the information on the item. The method may include reporting the information indicating the cause of scrapping the item to a subject corresponding to the confirmed cause of scrapping the item.

### [Effects]

According to example embodiments, it is possible for an electronic apparatus to analyze information on scrapped items to confirm the most important factor that has affected the scrap, analyze causes of scrap based on the confirmation, and select a representative scrap cause according to a priority among the effectively analyzed causes of scrap.

According to example embodiments, it is possible for an electronic apparatus to save time and cost until items are unloaded and stowed, thereby drastically reducing unnecessary item scrap and cost loss due to the scrap.

According to example embodiments, it is possible for an electronic apparatus to effectively prevent items from being scrapped or take measures against item scrap by adjusting an appropriate minimum order quantity or a sales amount due to the operations, thereby reducing unnecessary expenditures.

According to example embodiments, it is possible for an electronic apparatus to suggest a method in which an electronic apparatus for providing information related to an order determines a stock quantity of ordered items in a fulfillment center and consumption and demand for the ordered items and provides information on an order quantity calculated, thereby obtaining a technical effect of being capable of easily managing the order quantity of the ordered items.

According to example embodiments, it is possible for an electronic apparatus to use a decision tree by combining methods for analyzing various causes of scrap in a specific order or a preset order and confirm a scrap cause according to a priority to carefully analyze the scrap cause, thereby providing an effect of being capable of preventing items from being scrapped in the future.

### BRIEF DESCRIPTION OF THE DRAWINGS

FIG. 1 illustrates an example of internal components of an electronic apparatus according to example embodiments.

FIG. 2 is a flowchart illustrating an example of a method of providing information related to item scrap according to example embodiments.

FIG. 3 illustrates an example of causes of scrapping an item according to example embodiments.

FIG. 4 illustrates an example of causes of scrapping an item according to example embodiments.

FIG. 5 illustrates an example of a method of providing information corresponding to a scrap cause due to a minimum order quantity according to example embodiments.

FIG. 6 illustrates an example of a method of providing information related to item scrap corresponding to a scrap cause due to a defect in a fulfillment center according to example embodiments.

FIG. 7 illustrates an example of a method of providing information related to item scrap corresponding to a scrap cause due to a defect in a fulfillment center according to example embodiments.

FIG. 8 illustrates an example of a method of providing information related to item scrap corresponding to a scrap cause due to a defect in a fulfillment center according to example embodiments.

FIG. 9 illustrates an example of a method of providing information related to item scrap corresponding to a scrap cause due to a defect in a fulfillment center according to example embodiments.

FIG. 10 illustrates an example of a method of providing information related to item scrap corresponding to a scrap cause due to andon or debadge of an item.

FIG. 11 illustrates an example of a method of providing information related to item scrap corresponding to a scrap cause related to a forecast of a sales amount of an item according to example embodiments.

FIGS. 12A and 12B illustrate an example of a process of calculating an order quantity for a reference period starting from a specific reference date at a present time by an electronic apparatus according to example embodiments.

FIG. 13 illustrates an example of a method of providing information related to item scrap corresponding to a scrap cause due to overordering of an item.

FIG. 14 illustrates another example of internal components of an electronic apparatus according to example embodiments.

### DETAILED DESCRIPTION FOR CARRYING OUT THE INVENTION

Hereinafter, example embodiments of the present disclosure will be described in detail with reference to the accompanying drawings.

In describing the example embodiments, descriptions of technical contents that are well known in the technical field to which the present disclosure pertains and are not directly related to the present disclosure will be omitted. This is to more clearly convey the gist of the present disclosure without ambiguity by omitting unnecessary descriptions.

For the same reason, some components in the accompanying drawings are exaggerated, omitted, or schematically illustrated. In addition, the size of each component does not entirely reflect the actual size. The same reference numerals are assigned to the same or corresponding components in each drawing.

Various advantages and features of the present disclosure and methods accomplishing them will become apparent from example embodiments to be described in detail below with reference to the accompanying drawings. However, the present disclosure is not limited to example embodiments to be described below but may be implemented in various different forms, and these example embodiments will be provided only in order to make the present disclosure complete and allow those skilled in the art to completely recognize the scope of the present disclosure, and the present disclosure will be defined by the scope of the claims. Throughout the specification, like reference numerals denote like elements.

In this case, it will be appreciated that each block of a processing flowchart and combinations of the flowcharts may be executed by computer program instructions. Since these computer program instructions may be installed in a processor of a general computer, a special computer, or other programmable data processing apparatuses, these computer program instructions executed through the process of the computer or the other programmable data processing apparatuses create a unit for performing functions described in a block(s) of the flowchart. Since these computer program instructions may also be stored in a computer usable or computer readable memory of a computer or other programmable data processing apparatuses in order to implement the functions in a particular way, the computer program instructions stored in the computer usable or computer readable memory may also produce manufacturing articles including an instruction unit for performing the functions described in a block(s) of the flowchart. Since the computer program instructions may also be installed in the computer or the other programmable data processing apparatuses, the instructions perform a series of operation steps on the computer or the other programmable data processing apparatuses to create processes executed by the computer to run the computer or the other programmable data processing apparatuses, it may be possible to provide steps for performing the functions described in a block(s) of the flowchart.

In addition, each block may indicate some of modules, segments, or code including one or more executable instructions for executing a specific logical function (specific logical functions). Further, it is to be noted that functions mentioned in the blocks occur regardless of a sequence in some alternative example embodiments. For example, two blocks that are continuously shown may in fact be simultaneously performed or be performed in a reverse sequence depending on corresponding functions.

In this case, the term “˜ unit” used in this example embodiment refers to software or hardware components such as a field programmable gate array (FPGA) or an application specific integrated circuit (ASIC), and the “˜ unit” performs certain roles. However, “˜ unit” is not limited to the software or the hardware. The “˜ unit” may be configured to be in an addressable storage medium or may be configured to reproduce one or more processors. Therefore, as an example, the “˜ unit” includes components such as software components, object-oriented software components, class components and task components, processes, functions, attributes, procedures, subroutines, segments of program code, drivers, firmware, microcode, circuit, data, a database, data structures, tables, arrays, and variables. Components and functions provided within “˜ units” may be combined into a smaller number of components and “˜ units” or be further separated into additional components and “˜ units.” Furthermore, components and “˜ units” may be implemented to reproduce one or more central processing units (CPUs) in a device or a security multimedia card.

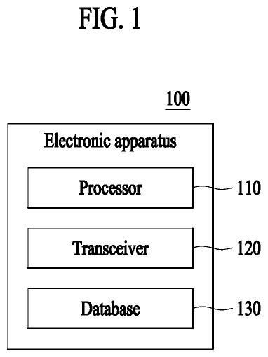

FIG. 1 is a diagram illustrating an example of internal components of an electronic apparatus according to example embodiments.

Referring to FIG. 1, internal components of an electronic apparatus 100 are not limited only to the illustrated components. The electronic apparatus 100 may include at least one of a processor 110, a transceiver 120, and a memory 130.

The processor 110 may process a series of operations for performing a method of providing information related to scrap of various items of the present disclosure. The processor 110 may control other components of the electronic apparatus 100. Meanwhile, in an example embodiment, a product may be used as a term referring to as a specific item, and an item may be sold to a user in a service related to the electronic apparatus 100.

The processor 110 may confirm detailed information on a first product in response to a request on a first page for the first product. When the processor 110 confirms through the memory 130 whether the first product is included in a specific category, the processor 110 may confirm at least one second product corresponding to the specific category. The processor 110 may confirm at least one attribute list corresponding to the specific category, and the attribute list may be stored in advance in the memory 130 or may be received from the outside through the transceiver 120. The processor 110 may provide the first page on a display of the electronic apparatus 100. The first page may include a first part in which the detailed information on the first product is provided, a second part in which first attribute information of the first product corresponding to the attribute list is provided, and a third part in which second attribute information of at least one second product corresponding to the attribute list is provided.

The transceiver 120 may perform a function of transmitting information stored in the memory 130 of the electronic apparatus 100 or information processed by the processor 110 to other devices or a function of receiving information from the other devices to the electronic apparatus 100.

The memory 130 has a data structure implemented in a predetermined storage space of the electronic apparatus 100, and thus, functions such as storing, searching, deleting, editing, or adding data may be freely performed. For example, the memory 130 may include fields or components for processing functions such as storing, searching, deleting, editing, or adding data. The memory 130 may store data related to performing a method of providing information related to item scrap by the electronic apparatus 100. For example, the memory 130 may store instructions or data for an execution operation of the processor 110.

The memory 130 according to the example embodiments may include a database for storing information on items, and the like.

The electronic apparatus 100 according to the example embodiments may perform the method of providing information related to item scrap according to the example embodiments described below. The electronic apparatus 100 may be referred to as, for example, an apparatus for providing information related to item scrap, an information providing apparatus, or the like.

In addition, an interface described in the present specification may be variously interpreted as a configuration of hardware for receiving an input signal from a user or an icon, a widget, a button, a slide bar, a progress bar, a touch area, or the like implemented in software.

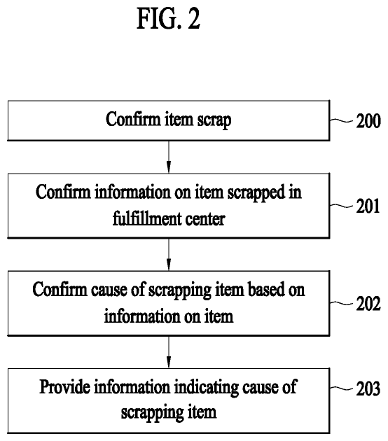

FIG. 2 is a flowchart illustrating an example of a method of providing information related to item scrap according to example embodiments.

The method of providing information related to item scrap according to the example embodiments illustrated in FIG. 2 may be performed by the electronic apparatus according to the example embodiments. The electronic apparatus may be, for example, the electronic apparatus 100 of FIG. 1. The electronic apparatus according to the example embodiments may perform some or all of the procedures of operations 200 to 203 illustrated in FIG. 2.

An item may include, for example, products, goods, or the like that have been ordered to a supplier and delivered from the supplier and may be stored in at least one fulfillment center (fulfillment center). Upon receiving an item from a supplier, the fulfillment center may unload the item and stow the item at a specific location within the fulfillment center. The fulfillment center may store items for a specific period or longer. When a purchaser purchases the item, the item may be released from a specific fulfillment center and shipped to the purchaser.

Meanwhile, when an item is stored in a fulfillment center for a long period of time, a problem may occur during unloading or stowing of the item, or an item may not be shipped or sold due to damage or the like, the item may be scrapped. However, when causes of scrap for each item is not accurately analyzed, there is a possibility that a supply and demand control of items may fail, and there is a concern that unnecessary items may continue to be scrapped. In addition, when a cause of scrapping an item an item is not accurately analyzed, there is a concern that an unnecessary waste of expenditures and burden on the fulfillment center may increase. Furthermore, when items are continuously scrapped, it is necessary to confirm a scrap cause in order to reduce an unnecessary burden by reducing the scrap quantity.

Accordingly, the electronic apparatus according to the example embodiments may analyze a cause of scrapping an item when the item scrap occurs and take possible actions in response to the cause of scrapping the item. Accordingly, the electronic apparatus according to the example embodiments may perform at least one of operations 200 to 203 illustrated in FIG. 2.

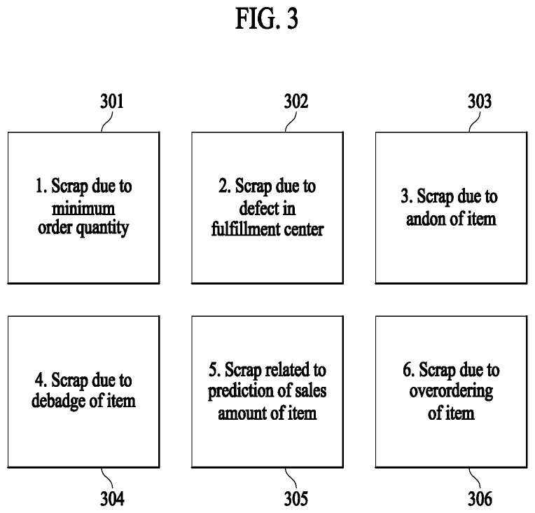

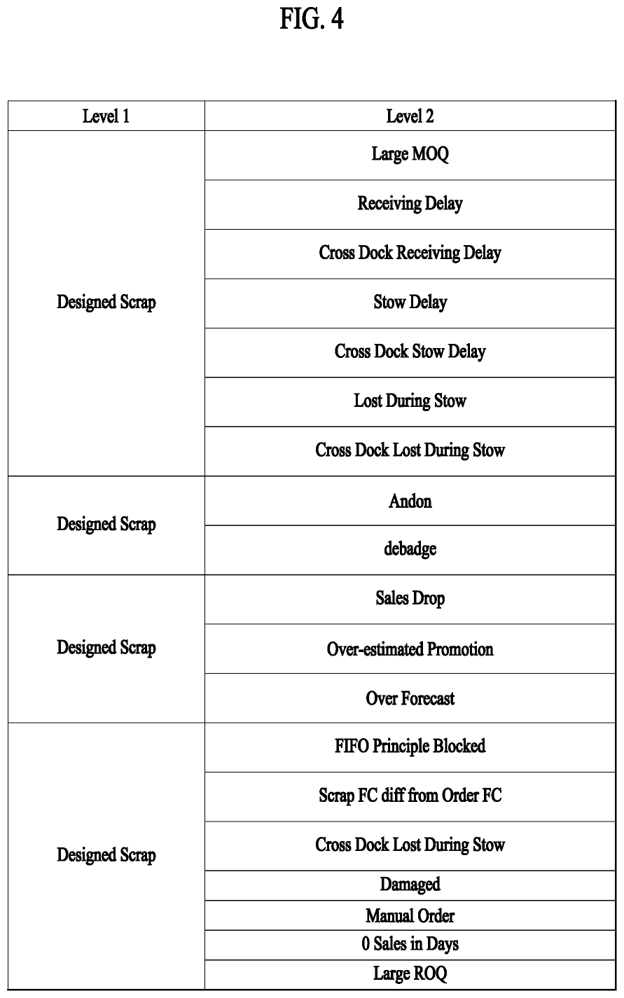

Referring to operation 200 of FIG. 2, the electronic apparatus according to the example embodiments may confirm item scrap. The cause of scrapping the item may vary. Examples of causes of scrapping an item will be described in detail with reference to FIGS. 3 and 4.

For example, in operation 200, the item scrap may be confirmed for each item unit, and the electronic apparatus according to the example embodiments may analyze causes of scrap for each item unit. For example, in operation 200, it is possible to confirm scrap of one or more items, and the electronic apparatus according to the example embodiments may analyze the scrap cause based on information on one or more items to select one or more causes of scrap (for example, a representative scrap cause). According to example embodiments, it is possible to analyze information on scrapped items to confirm the most important cause that has affected the scrap, analyze causes of scrap based on the confirmed cause, and select a representative scrap cause among the analyzed causes of scrap according to a priority.

Referring to operation 201 of FIG. 2, the electronic apparatus according to the example embodiments may confirm information on an item scrapped in a fulfillment center. The electronic apparatus according to the example embodiments may confirm information on items and information related to an order of an item in order to analyze the cause of scrapping the item.

The information on the item may include, for example, information (for example, a name of an item, a price of an item, or the like) indicating attributes of an item. The information on the item may include, for example, a sales amount (for example, a daily sales amount, a weekly sales amount, or the like) of an item, an average sales amount of an item within a specific period, a maximum sales amount of an item, preference (for example, a star score of an item) of an item, a current stock quantity of an item, a stock quantity of items in each fulfillment center, and a saleable period of an item, that is, a code life (for example, expiration date, or the like). The code life may also be information determined based on an expiration date and may be set to sell products for a period that is longer than a certain period based on the expiration date and determined based on the set period. Meanwhile, a sales amount of an item by period may be determined through an existing sales history, and a forecasted sales amount may also be included in the information on the item.

The information related to the order of the item may include, for example, information necessary for ordering the item. For example, the information related to the order of the item may include a list indicating a supplier(s) for ordering an item, an order quantity of an item, information indicating a minimum order quantity of a specific supplier, and the like.

Referring to operation 202 of FIG. 2, the electronic apparatus according to the example embodiments may confirm a cause of scrapping an item based on the information on the item.

Referring to operation 203 of FIG. 2, the electronic apparatus according to the example embodiments may provide the information indicating the cause of scrapping the item to an administrator. The electronic apparatus according to the example embodiments may transmit the information indicating the cause of scrapping the item to an administrator in the form of a notification or e-mail.

The electronic apparatus according to the example embodiments may further include reporting scrap information including the cause of scrapping the item. The electronic apparatus may, for example, determine the cause of scrapping the item as at least one of a plurality of causes of scrap.

The electronic apparatus according to the example embodiments may report the information indicating the cause of scrapping the item to a subject corresponding to the confirmed cause of scrapping the item. For example, when the cause of scrapping the item corresponds to scrap due to a minimum order quantity (301), the electronic apparatus may report the cause of scrapping the item to a department that manages an order of an item. For example, when the cause of scrapping the item corresponds to scrap due to a defect in a fulfillment center (302), the electronic apparatus may report the cause of scrapping the item to a fulfillment center storing an item or to a department related thereto. For example, when the cause of scrapping the item corresponds to scrap due to andon of an item (303), the electronic apparatus may report the cause of scrapping the item to a department in charge of item quality management, a department in charge of item delivery management, or the like. For example, when the cause of scrapping the item corresponds to scrap due to debadge of an item, the electronic apparatus may report to a fulfillment center storing an item or a department related thereto. For example, when a cause of scrapping an item corresponds to scrap related to a forecasted sales amount of an item (305), the electronic apparatus may report the cause of scrapping the item to a department (for example, a department in charge of marketing, or the like) that forecasts the sales amount of the item. For example, when a cause of scrapping an item corresponds to scrap due to overordering of an item (306), the electronic apparatus may report the cause of scrapping the item to a department that manages an order of the item.

When the electronic apparatus according to the example embodiments reports information indicating the cause of scrapping the item to a subject corresponding to the cause of scrapping the item, the electronic apparatus may provide information (for example, a code life of an item or the like) for determining the cause of scrapping the item and a process of determining the cause of scrapping the item to the subject corresponding to the cause of scrapping the item.

The electronic apparatus according to the example embodiments may analyze a cause of scrapping an item by comprehensively confirming information on item and information related to an order, thereby accurately detecting the cause of scrapping the item.

FIG. 3 is a diagram illustrating an example of causes of scrapping an item according to example embodiments.

The causes of scrapping an item according to the example embodiments illustrated in FIG. 3 may be a cause(s) of scrapping an item described in FIG. 2. The cause of scrapping the item according to example embodiments may include, for example, at least one of scrap due to a minimum order quantity (301), scrap due to a defect in a fulfillment center (302), scrap due to andon of an item (303), scrap due to debadge of an item (304), scrap related to a forecast of an sales amount of an item (305), and scrap due to overordering of an item.

The scrap due to the minimum order quantity (301) may refer to, for example, a cause of scrapping an item occurring due to a large minimum order quantity (MOO) requested by a supplier during a process of placing an order with the supplier. For example, when a minimum order quantity of an item required by a specific supplier is not sold within a specific period (for example, a code life indicating a saleable period of a supply item, and the like), the item may be scrapped. When the minimum order quantity required by the supplier is excessive and an item is inevitably scrapped, the cause of scrapping the item may be determined as the scrap due to the minimum order quantity (301).

The scrap cause due to the minimum order quantity (301) may be determined by the electronic apparatus, for example, based on information on an item and information related to an order. For example, information on an item may include a code life of the item and an average sales amount of the item for a specific period (for example, code life), and information related to an order may include a minimum order quantity (MOO) required by a supplier.

The electronic apparatus according to the example embodiments may calculate the minimum order quantity (MOO) by multiplying a code life and an average sales amount for a specific period. When the minimum order quantity (MOO) is greater than the product of the average sales amount for the specific period, the electronic apparatus may determine a cause of scrapping an item as the scrap due to the minimum order quantity (301).

According to the example embodiments, a code life may refer to an expiration date of an item, a period for which sales are possible from a date of supply or production according to laws, or a period for which sales are possible when sales are restricted by statutes.

The scrap due to the defect in the fulfillment center (302) may include, for example, a cause of scrapping items during unloading, receiving, or stowing the items within the fulfillment center. The scrap due to the defect in the fulfillment center (302) may include, for example, a scrap cause in which an item is unloaded late in a fulfillment center, and thus, is inevitably scrapped, a scrap cause in which an item is stowed late, and thus, is inevitably scrapped, a scrap cause in which an item is lost in a fulfillment center, and thus, is inevitably scrapped, and the like. That is, the scrap cause due to the defect in the fulfillment center (302) may include a first scrap sub-cause related to a receiving(unloading) delay of an item, a second scrap sub-cause related to a stowing delay of an item, and a third scrap sub-cause related to loss of an item.

The scrap due to the defect in the fulfillment center (302) may be similarly applied to an item, for example, even when the item is received in the fulfillment center through a cross dock. The cross dock may refer to, for example, that when a specific item moves from a supplier to the first fulfillment center, the specific item moves from the first fulfillment center to the second fulfillment center to be stored in the second fulfillment center and is received in the second fulfillment center.

For example, there may be a case where an item is unloaded from a supplier in the first fulfillment center and then loaded again in the first fulfillment center, moved to the second fulfillment center, and then unloaded and received in the second fulfillment center. Therefore, when an item is received in a fulfillment center in the form of a cross dock, a scrap cause occurring during the unloading, receiving, or stowing may be analyzed based on the time when the item is received in the first fulfillment center. When scrap occurs according to a procedure of each operation performed in such a fulfillment center, a work process corresponding to each operation and the number of employees may be adjusted based on the scrap quantity and the time of scrap for each operation.

The scrap due to the defect in the fulfillment center (302) may be determined by an electronic apparatus based on, for example, information related to an order of an item and information on an item. The information on the item may include, for example, Information indicating an unloading start time of an item in a fulfillment center, information indicating an unloading completion time, information indicating a scheduled receiving(unloading) time of an item, information indicating an unloading amount of an item, information indicating a confirmed quantity of an item received, information indicating a time when an item is scrapped, information indicating a stowing quantity of an item, information indicating a time an item was stowed, information indicating a cycle in which an item is received, information indicating whether an item is received in a direct delivery form in which the item is delivered directly from a supplier or in a cross dock form in which the item is delivered through another fulfillment center, a scrap quantity of an item within a specific period, the amount of defects of an item within a specific period, or the like. The information related to the order of the item may include, for example, information indicating a quantity of an item that has been decided to be delivered from a specific supplier, or the like.

For example, when there is a problem with a specific item (for example, when a customer complains about an item, or when a problem occurs in the process of delivering an item to a customer), in the scrap due to the andon of the item (303) the item may not be sold until the problem is resolved, and therefore, may be a scrap cause caused by not selling items. The andon may refer to, for example, that when there is a problem with a specific item, the item is not sold until the problem is resolved. The problem with the item may include, for example, a case in which a customer's complaint reason for an item is received, and thus, needs to be resolved, and may include a case in which safety issues or statutory issues of an item limit sales of the item, and thus, need to be resolved

The scrap due to the andon of the item (303) may be determined by the electronic apparatus based on the information related to the order of the item and the information on the item. The information related to the order of the item may include, for example, information on a purchase order status of an item. When the order status of the item indicates that the item is in the andon status (that is, when the value of the information on the order status of the item indicates is in the andon status), the item may not be sold to purchasers even when the item is in stock in a fulfillment center.

Accordingly, when the information on the purchase order status of the item within the specific period is the andon status, the electronic apparatus according to the example embodiments may determine the cause of scrapping the item as the scrap due to the andon of the item (303).

The scrap due to the debadge of the item (304) may refer to a cause that for example, when a sales amount of an item increases and thus exceeds an available shipment quantity of the item, the item may not be sold even when the item is in stock in a fulfillment center, and therefore, the item remains in the fulfillment center without being sold and scrapped. In an example embodiment, the debadge may include items whose sales are stopped in a sales server for a specific reason.

The electronic apparatus according to the example embodiments may determine the scrap due to the debadge of the item (303) based on the information indicating the sales amount of the item within a specific period and the maximum available shipment quantity of the item within the fulfillment center. For example, when a sales amount for a specific period is excessive within a specific period (for example, the specific period may also be checked in a unit of 1 day, 1 week, or 1 hour), and thus, exceeds the maximum available shipment quantity of the item within the specific period, the electronic apparatus may change the shipment status of the item from an active status to a debadge status.

Accordingly, the electronic apparatus according to the example embodiments may confirm information indicating the shipment status of the item by period and sales pattern information indicating sales details of the items by period when the item scrap occurs. The electronic apparatus according to the example embodiments may confirm the shipment status by period to confirm the period for which the shipment status of the item is in the debadge state. The electronic apparatus may confirm the sales amount of the item for the period for which the shipment status of the item is in the debadge state and the maximum available shipment quantity of the item for the period for which the shipment status of the item is in the debadge state. The electronic apparatus may confirm a difference between the confirmed maximum available delivery quantity and the sales amount of the item, and when the confirmed difference is greater than or equal to a specific percentage (for example, 30%) of the scrap quantity of the entire item, may determine a cause of scrapping an item as the scrap due to the debadge of the item (304).

The scrap related to the forecast of the sales amount of the item (305) may be a cause that scrap occurs due to a difference in a forecast although an order is placed with a supplier by forecasting a sales amount of an item and determining an order quantity based on the forecasted result. The electronic apparatus according to the example embodiments may forecast a sales amount of an item before placing an order with a supplier, determine an order quantity based on the forecasted result, and then transmit an order. However, there may be cases where the forecast of the sales amount is wrong due to a sudden change in a sales amount, a social problem, or the like. Therefore, when the difference between the sales amount predicted by the electronic apparatus according to the example embodiments and the forecast sales amount is greater than or equal to a specific degree, a cause of scrapping an item may be determined as scrap related to a forecast of a sales amount of an item (305).

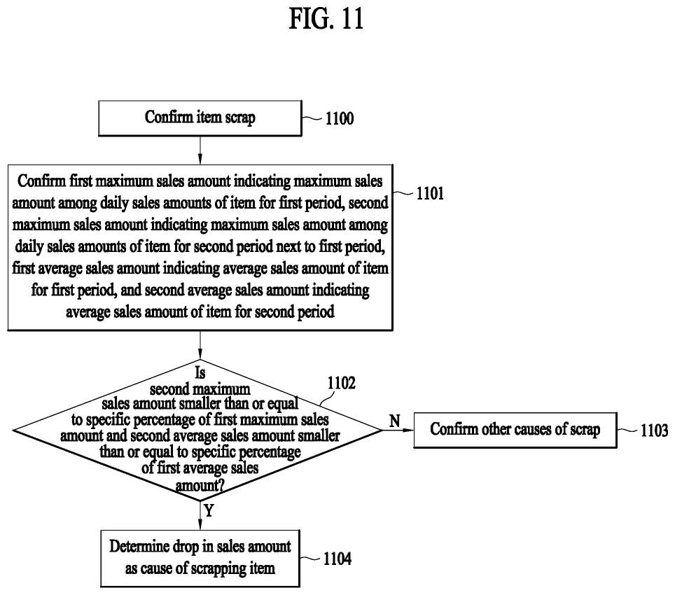

The scrap related to the forecast of the sales amount of the item (305) may include a fourth scrap sub-cause which is a cause that a forecast error of a sales amount occurs due to a sales drop of an item, and thus, scrap occurs, and a fifth scrap sub-cause which is a cause that the forecasted sales amount is larger than an actual sales amount of an item, and thus, scrap occurs. A method in which the electronic apparatus according to the example embodiments determines whether the cause of scrapping the item is the scrap related to the forecast of the sales amount of the item (305) will be described in detail with reference to FIG. 11.

The scrap due to the overordering of the item (306) may be, for example, a case in which a quantity actually ordered from a supplier is larger than an average sales amount of an item within a saleable period (for example, code life) and within a specific period, and thus, the item scrap occurs.

For example, when a total sales amount sold for a specific period (for example, a saleable period, a code life, or the like for an ordered and received item,) of a specific item is greater than or equal to a specific percentage of the actually ordered item, the item may be scrapped. In this case, the cause of scrapping the item may be the scrap due to overordering (306).

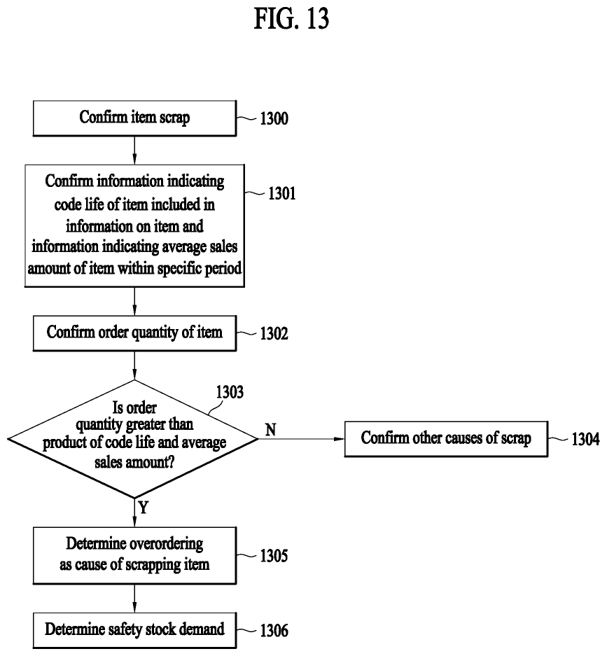

The scrap due to overordering (306) may refer to a case in which an item is excessively ordered from a supplier as compared with the order quantity of the item and the actually sold quantity of the item, and thus, scrap occurs. The scrap due to overordering (306) will be described in detail with reference to FIG. 13.

Meanwhile, in the example embodiment, when the specific cause has a large effect on item scrap, the information related to the scrap may be provided to a person in charge who sets a parameter corresponding to the cause. In addition, when the parameter corresponding to the cause is set later based on the cause that has affected the scrap, a quantity of scrapped items and scrap time may be considered in response to the cause.

FIG. 4 is a diagram illustrating an example of causes of scrapping an item according to example embodiments.

A table shown in FIG. 4 shows an example of classifying a cause of scrapping an item according to example embodiments in units of levels. The table shown in FIG. 4 shows an example of a hierarchical decision tree in which a cause of scrapping an item is hierarchical. The electronic apparatus according to the example embodiments may include the hierarchical decision tree illustrated in FIG. 4, and may confirm the cause of scrapping the item based on the hierarchical decision tree.

Referring to FIG. 4, a level may represent, for example, a vertical relationship of classification. For example, causes of scrapping an item displayed in a column of level 1 may represent a large category, and causes of scrapping items displayed in a column of level 2 may represent a scrap sub-cause of a specific large category.

As illustrated in FIG. 4, the electronic apparatus according to the example embodiments may determine a specific cause of scrapping an item as one of the causes of scrap shown in level 1 and determine the specific cause of scrapping the item as one of the causes of scrap shown in level 2 by analyzing the specific cause of scrapping the item in more detail.

The electronic apparatus according to the example embodiments may analyze a scrap cause in the order of the scrap cause going from the top to the bottom of the table illustrated in FIG. 4. For example, the electronic apparatus according to the example embodiments may first confirm a scrap cause corresponding to a designed scrap, confirm a scrap cause corresponding to a fulfillment center, analyze a scrap cause corresponding to an abnormal cause, analyze a scrap cause corresponding to a forecast, and then a scrap cause corresponding to others.

Referring to FIG. 4, a cause of scrapping an item according to example embodiments may include the designed scrap cause. The designed scrap cause may represent scrap when scrap occurs due to an inevitable cause for a specific item. The designed scrap cause may include the first scrap cause (301) of FIG. 3. The designed scrap cause may include a scrap cause due to a large minimum order quantity (large MOQ).

Referring to FIG. 4, the cause of scrapping the item according to the example embodiments may include a scrap cause of a fulfillment center. The scrap cause of the fulfillment center may represent a case in which the item scrap occurs due to the defect in the fulfillment center or a problem in the fulfillment center. The scrap cause of the fulfillment center may include the second scrap cause (302) of FIG. 3.

Referring to FIG. 4, the cause of scrapping the item according to the example embodiments may include the scrap cause due to an abnormal cause. The scrap cause due to the abnormal cause may represent scrap when an abnormal situation occurs for a specific item and scrap occurs due to the abnormal situation. The scrap cause of the abnormal cause may include the third scrap cause (303) and the fourth scrap cause (304) of FIG. 3. The scrap cause of the abnormal cause may include, for example, the scrap cause due to andon of an item, and a scrap cause due to debadge of an item.

Referring to FIG. 4, the cause of scrapping the item according to the example embodiments may include the scrap cause due to a forecast. The scrap cause due to the forecast may represent a case in which the item scrap occurs due to the forecast error of the sales amount of the item. The scrap cause due to the forecast may include the fifth scrap cause (305) of FIG. 3. Referring to FIG. 4, the cause of scrapping the item according to the example embodiments may include the scrap cause due to others. The scrap cause due to others may include the sixth scrap cause (306) of FIG. 3 or the like.

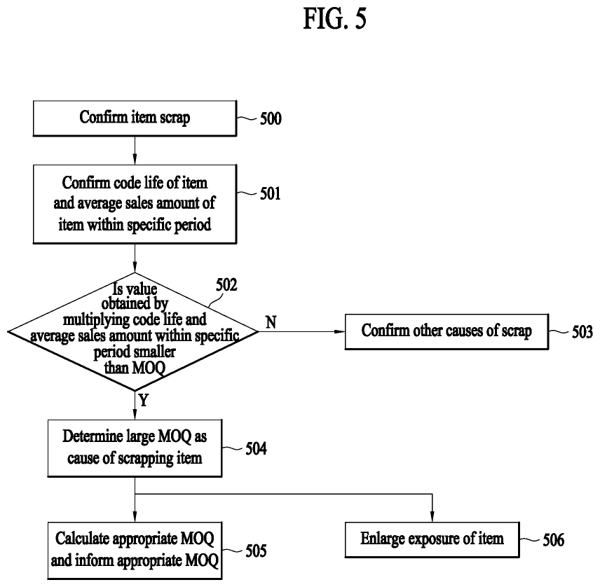

FIG. 5 is a diagram illustrating an example of a method of providing information corresponding to a scrap cause due to a minimum order quantity according to example embodiments.

The method of providing information related to item scrap according to the example embodiments illustrated in FIG. 5 may be performed by the electronic apparatus according to the example embodiments. The electronic apparatus according to the example embodiments may perform some or all of operations 200 to 203 illustrated in FIG. 2. The electronic apparatus according to the example embodiments may perform some or all of operations 500 to 506 illustrated in FIG. 5.

The electronic apparatus according to the example embodiments may first confirm item scrap in operation 500.

The electronic apparatus according to the example embodiments may confirm a code life of an item and an average sales amount of an item within a specific period in operation 501. According to example embodiments, a code life and an average sales amount of an item within a specific period may be included in the information on the item according to the example embodiments. That is, the electronic apparatus according to the example embodiments confirms the code life of the item and the average sales amount of the item within the specific period from the information on the item. The specific period may be a period corresponding to the code life of the item.

The electronic apparatus according to the example embodiments may compare a value obtained by multiplying the code life and the average sales amount within the specific period with the minimum order quantity (MOO) of the item in operation 502. The value obtained by multiplying the code life and the average sales amount within the specific period may refer to, for example, the total quantity of items sold for the period corresponding to the code life.

The minimum order quantity may be, for example, a minimum order quantity of an item when an item is ordered at a specific period (for example, a code life). For example, when a period for which a specific item is ordered and received in a fulfillment center is a period of the code life of the item, it is ideal that the minimum order quantity of the item needs to match the sales amount sold for the period. However, when the sales amount sold for the period corresponding to the code life of the item is smaller than the minimum order quantity of the item, the item scrap may occur as much as the quantity of the remaining items.

That is, when the value obtained by multiplying the code life and the average sales amount within the specific period is greater than or equal to the minimum order quantity of the item, the electronic apparatus according to the example embodiments may confirm other causes of scrap in operation 503.

In addition, when the value obtained by multiplying the code life and the average sales amount within the specific period is smaller than the minimum order quantity of the item, the electronic apparatus according to the example embodiments may determine a large MOQ as the cause of scrapping the item in operation 504.

In this case, when the large MOQ is determined as the cause of scrapping the item, the electronic apparatus according to the example embodiments may calculate an appropriate minimum order quantity of the item and inform the calculated appropriate MOQ in operation 505. That is, the electronic apparatus according to the example embodiments may analyze a sales amount of an item and calculate the appropriate minimum order quantity of the item to negotiate with a supplier.

The appropriate minimum order quantity may confirm, for example, a sales amount or the like for a plurality of periods (for example, a first period and a second period next to the first period) from the information on the item, confirm a sales trend of the item from the sales amount for the plurality of periods, and then determine the appropriate minimum order quantity according to the trend.

For example, the electronic apparatus according to the example embodiments may confirm a first average sales amount indicating an average sales amount of an item for a first period and a second average sales amount indicating an average sales amount of an item for a second period next to the first period. When the second average sales amount is smaller than or equal to the first average sales amount, the electronic apparatus according to the example embodiments may calculate the appropriate minimum order quantity corresponding to the item based on the first average sales amount and the second average sales amount.

When the large MOQ is determined as the cause of scrapping the item, the electronic apparatus according to the example embodiments may enlarge a degree of exposure of an item in operation 506. For example, the electronic apparatus according to the example embodiments may confirm the first average sales amount indicating the average sales amount of the item for the first period and the second average sales amount indicating the average sales amount of the item for the second period next to the first period. For example, when the second average sales amount is greater than the first average sales amount, an exposure priority of the item may increase. The exposure priority may refer to, for example, a location exposed to a search result while searching for items or a priority of items exposed to users. For example, an item with a high exposure priority is more likely to be located in a prominent location on a main page. For example, an item with a low exposure priority may be set to be exposed in a search result only by searching for a name of the item without change.

According to example embodiments, when the second average sales amount calculated as described above is greater than the first average sales amount, the sales amount may still not reach the appropriate minimum order quantity even when the sales amount of the item tends to continuously increase. Accordingly, when the second average sales amount is greater than the first average sales amount, the electronic apparatus according to the example embodiments may expose an item on the main page to increase the sales amount, thereby preventing the scrap. According to example embodiments, for example, a main page that users visit may include an area(s) in which information on a specific item is exposed. The electronic apparatus according to the example embodiments may promote sales by exposing the item(s) to the areas.

According to various example embodiments, it is possible for the electronic apparatus to effectively prevent items from being scrapped or take measures against the item scrap by adjusting the appropriate minimum order quantity or the sales amount due to the operations, thereby reducing unnecessary expenditures.

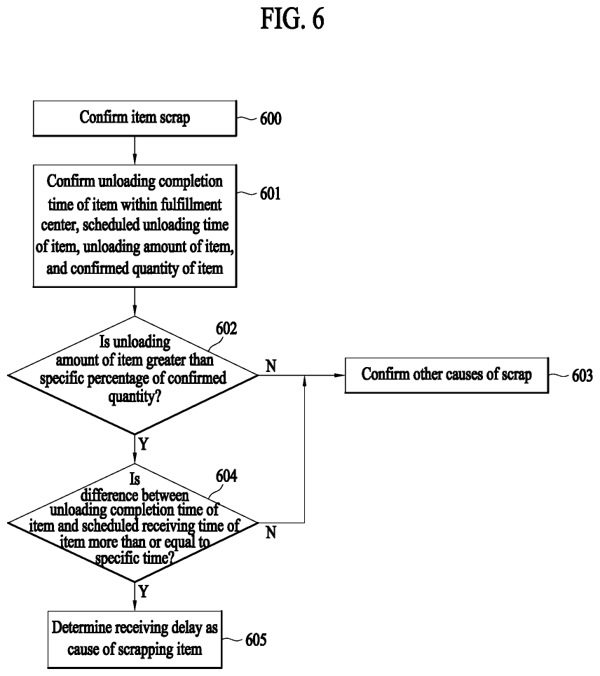

FIG. 6 is a diagram illustrating an example of a method of providing information related to item scrap corresponding to a scrap cause due to a defect in a fulfillment center according to example embodiments.

The method of providing information related to item scrap according to the example embodiments illustrated in FIG. 6 may be performed by the electronic apparatus according to the example embodiments. The electronic apparatus according to the example embodiments may perform some or all of the operations illustrated in FIG. 6. The electronic apparatus according to the example embodiments may perform some or all of operations 600 to 605 illustrated in FIG. 6.

The electronic apparatus according to the example embodiments may first confirm item scrap in operation 600.

The electronic apparatus according to the example embodiments may confirm an unloading completion time of an item, a scheduled receiving(unloading) time of an item, an unloading amount of an item, and a confirmation quantity of an item within a fulfillment center from the information on the item in operation 601.

The unloading completion time of the item may be, for example, a time when unloading is completed when an item arrives at the fulfillment center from a supplier and then is unloaded. For example, the unloading completion time of the item may refer to a time when all items of a specific quantity are unloaded when the items are supplied in the specific quantity from a supplier to the fulfillment center according to a specific order request and unloaded.

The scheduled receiving (unloading) time of the item may refer to a time when all the items of the specific quantity are unloaded and then enter the fulfillment center. The unloading amount of the item may refer to the specific quantity received and unloaded by the specific order request from the supplier to the fulfillment center. The confirmed quantity of the item may refer to a quantity of an item that has actually been received among the items of the specific quantity that have been unloaded. That is, the confirmed quantity of the item may refer to the confirmed quantity of the item after it is confirmed whether the item has actually arrived at the fulfillment center without any problem.

The electronic apparatus according to the example embodiments may confirm whether the unloading amount of the item is greater than or equal to a specific percentage of the confirmed quantity of the item (first condition) in operation 602. The specific percentage may be, for example, 80%.

When the unloading amount of the item is smaller than the specific percentage of the confirmed quantity of the item (that is, when the first condition is not satisfied), the electronic apparatus according to the example embodiments may confirm other causes of scrap in operation 603.

When the unloading amount of the item is greater than or equal to the specific percentage of the confirmed quantity of the item (that is, when the first condition is satisfied), the electronic apparatus according to the example embodiments may confirm whether the difference between the unloading completion time of the item and the scheduled receiving (unloading) time of the item is more than or equal to a specific time (time difference of receiving delay) (second condition) in operation 604.

For example, the time (that is, scheduled receiving time) when the item is delivered and is scheduled to be received from a supplier is a D day, but when the unloading of the item is completed at a specific time (for example, 1:30 a.m.) on a D+1 day, the cause of scrapping the item may be determined as the receiving (unloading) delay.

The electronic apparatus according to the example embodiments may differently determine the time difference of the receiving (unloading) delay according to the example embodiments by using information indicating characteristics of an item. For example, when an item is a product delivered at dawn, the scheduled receiving (unloading) time of the item is the D day, but when the unloading of the item is completed at the specific time (for example, 6:30 am) on the D+1 day, the cause of scrapping the item may be determined as the receiving (unloading) delay.

When the difference between the unloading completion time of the item and the scheduled receiving (unloading) time of the item is less than a specific time (that is, when the second condition is not satisfied), the electronic apparatus according to the example embodiments may confirm other causes of scrap in operation 603.

When the difference between the unloading completion time of the item and the scheduled receiving (unloading) time of the item is greater than or equal to the specific time (that is, when the second condition is satisfied), the electronic apparatus according to the example embodiments may determine the cause of scrapping the item as the scrap due to the receiving (unloading) delay in operation 605.

The electronic apparatus according to the example embodiments may confirm a cause of scrapping an item by changing the order of the first condition and the second condition.

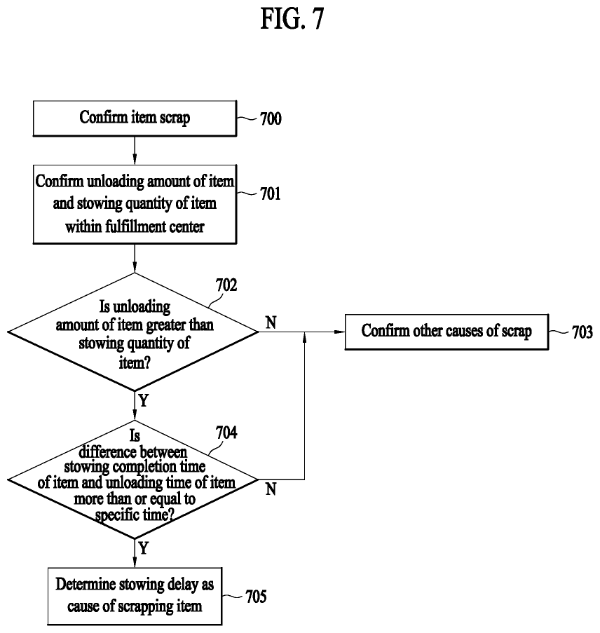

FIG. 7 is a diagram illustrating an example of a method of providing information related to item scrap corresponding to a scrap cause due to a defect in a fulfillment center according to example embodiments.

The method of providing information related to item scrap according to the example embodiments illustrated in FIG. 7 may be performed by the electronic apparatus according to the example embodiments. The electronic apparatus according to the example embodiments may perform some or all of the operations illustrated in FIG. 7. The electronic apparatus according to the example embodiments may perform some or all of operations 700 to 705 illustrated in FIG. 7.

The electronic apparatus according to the example embodiments may first confirm item scrap in operation 700.

The electronic apparatus according to the example embodiments may confirm an unloading amount of an item, an unloading time of an item, a stowing completion time of an item, and a stowing quantity of an item within a fulfillment center from the information on the item in operation 701.

The electronic apparatus according to the example embodiments may confirm whether the unloading amount of the item is greater than the stowing quantity of the item (third condition) in operation 702.

For example, when the electronic apparatus according to the example embodiments confirms item scrap, the electronic apparatus may confirm the unloading amount of the item and how many items have been unloaded on the day when the item scrap occurs and the time when the item is unloaded.

When the unloading amount of the item is not greater than the stowing quantity of the item (that is, the third condition is not satisfied), the electronic apparatus according to the example embodiments may confirm other causes of scrap in operation 703. That is, when all the unloaded items are stowed at the time when the item is unloaded, it may be seen that currently scrapped items are not due to the receiving (unloading) delay.

Meanwhile, in a situation where items are unloaded, but all the items that have been unloaded are not stowed, it is necessary to confirm whether the reason for not being stowed is due to a stowing delay or there are other causes (for example, loss or the like) during the stowing. Therefore, when the unloading amount of the item is greater than the stowing quantity of the item (that is, when the third condition is satisfied), the electronic apparatus according to the example embodiments may further confirm whether a difference between a stowing completion time of an item and an unloading time of an item is a specific time or more (fourth condition) in operation 704.

Meanwhile, an item may be received in a direct delivery form in which the item is delivered directly from a supplier to a fulfillment center but may be received in a cross dock form in which the item is received in a targeted fulfillment center via one or more fulfillment centers from a supplier. That is, the direct delivery refers to, for example, a receiving form in which an item is directly received in a specific fulfillment center from a supplier without transiting through another fulfillment center(s). The cross dock refers to, for example, a receiving form in which an item is received via a fulfillment center, not a form in which an item is directly received in the specific fulfillment center from a supplier.

In the electronic apparatus according to the example embodiments, when an item is received in the specific fulfillment center in the cross dock form, an unloading time of an item may be a time when an item first arrives at a fulfillment center. For example, when a specific item from a supplier is unloaded in a first fulfillment center, and then delivered from the first fulfillment center to a second fulfillment center and received in the second fulfillment center, the time when an item is unloaded in the first fulfillment center may be an unloading time of an item according to example embodiments. In this case, the stowing completion time of the item may refer to the time when the item is actually received and stowed in the second fulfillment center. Accordingly, when an item is received in the specific fulfillment center in the cross dock form, the difference between the stowing completion time of the item and the unloading time of the item may be greater than when the item is received in the specific fulfillment center in the direct delivery form. Accordingly, the specific time compared in operation 704 of FIG. 7 may be set differently depending on an order type of an item, that is, whether an item is received in the direct delivery form or an item is received in a cross dock form. In addition, even when an item is received in the cross-dock form, the specific time may be set differently depending on the number of transiting fulfillment centers transited, capacity of the transited fulfillment centers, a distance between the transited fulfillment centers, a transit distance, an order quantity of an item to be ordered, delivery cost of an item, and the like.

Here, whether the item is received in the direct delivery form, whether the item is received in the cross dock form, the number of transited fulfillment centers when an item is received in the cross dock form, the capacity of the transited fulfillment centers, the distance between the transited fulfillment centers, the transit distance, the order quantity of the item to be ordered, and the delivery cost of the item may be included in information on an order of an item.

When the difference between the display completion time of the item and the unloading time of the item is less than the specific time, the electronic apparatus according to the example embodiments may confirm other causes of scrap (for example, loss or the like) in operation 703. When the difference between the stowing completion time of the item and the unloading time of the item is the specific time or more, the electronic apparatus according to the example embodiments may confirm the stowing delay as the cause of scrapping the item in operation 705.

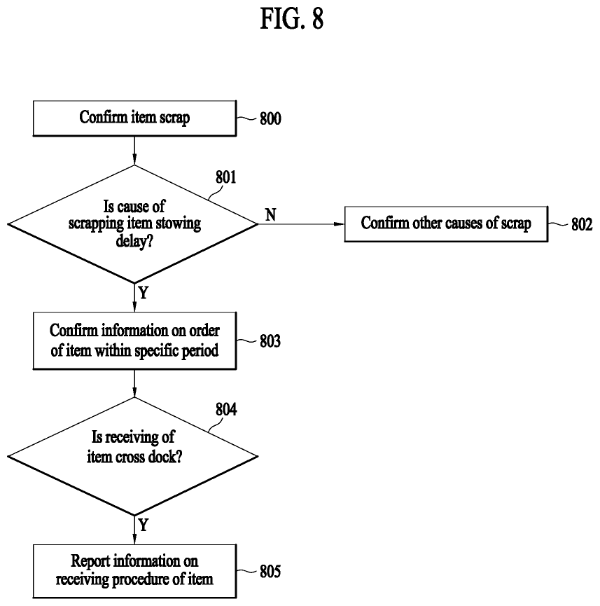

FIG. 8 is a diagram illustrating an example of a method of providing information related to item scrap corresponding to a scrap cause due to a defect in a fulfillment center according to example embodiments.

The method of providing information related to item scrap according to the example embodiments illustrated in FIG. 8 may be performed by the electronic apparatus according to the example embodiments. The electronic apparatus according to the example embodiments may perform some or all of the operations illustrated in FIG. 8. The electronic apparatus according to the example embodiments may perform some or all of operations 800 to 805 illustrated in FIG. 8.

Referring to FIG. 8, the electronic apparatus according to the example embodiments may confirm item scrap in operation 800. Operation 800 of FIG. 8 may correspond to an operation of confirming item scrap of FIGS. 5 to 7.

Referring to FIG. 8, the electronic apparatus according to the example embodiments may confirm whether a cause of scrapping an item is due to a stowing delay. Operation 801 of FIG. 8 may include some or all of operations 700 to 705 illustrated in FIG. 7. The electronic apparatus according to the example embodiments may confirm other causes of scrap when the cause of scrapping the item is not the stowing delay in operation 802. When the cause of scrapping the item is the above-described stowing delay, information on an order within a specific period of an item may be confirmed from the information on the item.

The information on the order may include, for example, the information on the order described with reference to FIG. 7. In other words, the information on the order may include information on a purchase order status indicating whether an order for the item is currently being processed from a supplier or is active, information indicating an order details (for example, an order date, an order quantity, information indicating information on a supplier that has placed an order, and the like) of the item, information on a fulfillment center in which the item is ordered and received, and the like. The information on the order may include, for example, information indicating whether the item is received in a specific fulfillment center in a direct delivery form or a cross dock form.

When the cause of scrapping the item is confirmed in operation 800 and then the cause of scrapping the item is the stowing delay of the item within the fulfillment center in operation 801, the electronic apparatus according to the example embodiments needs to confirm the information on the order of the item to change a procedure to simplify the process of unloading and stowing the item or shorten the time therefor. For example, when an item is received in the cross dock form and item scrap occurs due to the stowing delay, the number of fulfillment centers the item transits through may be reduced or the transit path may be shortened.

Accordingly, the electronic apparatus according to the example embodiments may confirm whether the item is received in the cross dock form based on the information on the order in order to solve this problem. When the item is received in the cross dock form, the electronic apparatus according to the example embodiments may report information on the procedure of receiving the item in operation 805.

The procedure of receiving the item may include, for example, information on a past receiving procedure indicating a process in which the item is received to the present and information on a changed receiving procedure indicating a process of receiving an improved item. The information on the past receiving procedure includes, for example, information on at least one fulfillment center that an item transits, a total transit distance which an item transits until arriving at a final fulfillment center, a moving distance between the respective fulfillment centers, a quantity of an item received and moved in each fulfillment center, cost and time required for moving the item, and the like.

That is, when the item is received in the cross dock form, the item scrap occurs, and the scrap cause is the stowing delay, the electronic apparatus according to the example embodiments may change the fulfillment center(s) to be transited during the process of receiving the item.

The electronic apparatus according to the example embodiments may save time and costs until the item is unloaded and stowed due to the operation, thereby drastically reducing unnecessary item scrap and costs due to the scrap.

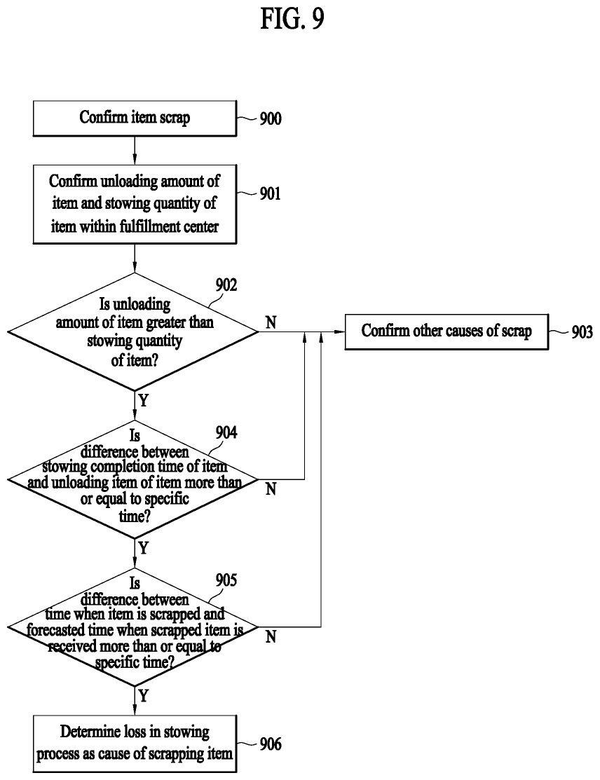

FIG. 9 is a diagram illustrating an example of a method of providing information related to item scrap corresponding to a scrap cause due to a defect in a fulfillment center according to example embodiments.

The method of providing information related to item scrap according to the example embodiments illustrated in FIG. 9 may be performed by the electronic apparatus according to the example embodiments. The electronic apparatus according to the example embodiments may perform some or all of the operations illustrated in FIG. 9. The electronic apparatus according to the example embodiments may perform some or all of operations 900 to 907 illustrated in FIG. 8. Referring to FIG. 9, the electronic apparatus according to the example embodiments may confirm item scrap in operation 900. Operation 900 of FIG. 9 may correspond to an operation of confirming item scrap of FIGS. 5 to 8.

The electronic apparatus according to the example embodiments confirms whether specific conditions are satisfied when item scrap occurs to confirm whether a cause of scrapping an item is a scrap cause due to a defect in a fulfillment center, and specifically, whether a cause of scrapping an item is loss during stowing or a stowing delay.

Referring to FIG. 9, the electronic apparatus according to the example embodiments may confirm an unloading amount of an item and a stowing quantity of an item within a fulfillment center in operation 901. The unloading amount of the item may refer to a quantity of items that are delivered from a supplier based on a specific order and received and unloaded in a fulfillment center. The stowing quantity of the item may refer to the number of items stowed in the corresponding fulfillment center among the items that have been unloaded and received according to the order. The unloading amount and stowing quantity of the item may be confirmed for items received based on the specific order.

The electronic apparatus according to the example embodiments may compare the unloading amount of the item and the stowing quantity of the item in operation 902. In addition, the electronic apparatus according to the example embodiments may confirm a stowing completion time of an item and an unloading completion time of an item, and confirm whether a difference between the stowing completion time of the item and the unloading time of the item is a specific time or more in operation 904.

For example, when the unloading amount of the item is smaller than or equal to the stowing quantity of the item or the difference between the stowing completion time of the item and the unloading time of the item is less than the specific time, since the items received based on the order are not lost during the unloading and stowing or the stowing delay does not occur, the electronic apparatus according to the example embodiments may confirm other causes of scrap in operation 903.

For example, in the electronic apparatus according to the example embodiments, when the unloading amount of the item is greater than the stowing quantity of the item and the difference between the stowing completion time of the item and the unloading time of the item is the specific time or more, the items received based on the order may be lost during the unloading and stowing, and some of the items that have been unloaded may not displayed in the fulfillment center. That is, in this case, the loss during the stowing may be the cause of scrapping the item, or the unloading or the stowing delay may be the cause of scrapping the item.

Accordingly, the electronic apparatus according to the example embodiments may further confirm whether the difference between the time when the item is scrapped and the forecasted receiving time of the scrapped item is greater than or equal to a specific time in operation 905. When the difference between the time when the item is scrapped and the forecasted receiving time of the scrapped item is the certain time or more, since the stowing of the item is delayed and the scrap occurs although the item is scheduled to be received, the electronic apparatus according to the example embodiments may confirm that the item is lost during the stowing, and thus, the item is scrapped Therefore, when the difference between the time when the item is scrapped and the forecasted receiving time of the item is the specific time or more, the electronic apparatus according to the example embodiments may determine the cause of scrapping the item as the loss during the stowing in operation 906. Meanwhile, the electronic apparatus according to the example embodiments may further confirm other causes of scrap when the difference between the time when the item is scrapped and the forecasted receiving time of the scrapped item is less than the specific time in operation 903.

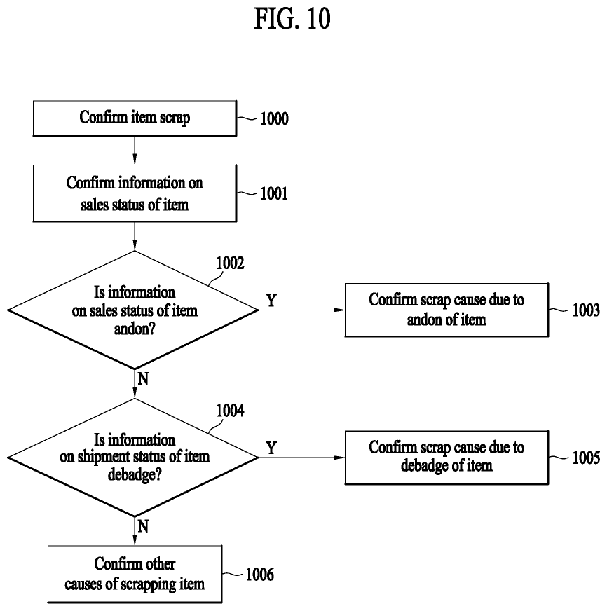

FIG. 10 is a diagram illustrating an example of a method of providing information related to item scrap corresponding to a scrap cause due to andon or debadge of an item.

The method of providing information related to item scrap according to example embodiments illustrated in FIG. 10 may be performed by the electronic apparatus according to the example embodiments. The electronic apparatus according to the example embodiments may perform some or all of the operations illustrated in FIG. 10. The electronic apparatus according to the example embodiments may perform some or all of operations 1000 to 1006 illustrated in FIG. 10. Referring to FIG. 10, the electronic apparatus according to the example embodiments may confirm item scrap in operation 1000. Operation 1000 of FIG. 10 may correspond to an operation of confirming item scrap of FIGS. 5 to 9.

When item scrap occurs, the electronic apparatus according to the example embodiments may confirm whether specific conditions are satisfied to confirm whether a cause of scrapping an item is scrap due to andon or debadge.

The electronic apparatus according to the example embodiments may confirm sales status information of an item in operation 1001. For example, the sales status information may include a sales amount of items by period, a shipment status of items by period, a sales status of items by period, and a maximum available shipment quantity at which a fulfillment center may ship an item for a specific period (for example, 1 day, 1 week, or the like).

A sales status of an item by period indicates, for example, whether the item may not be sold due to a problem with the item within a specific period or circumstances in which the item may not be sold. When item scrap occurs, the electronic apparatus according to the example embodiments may determine whether a cause of scrapping an item is andon by using the sales status of the item by period.

The shipment status of the item by period may be information indicating whether a current item may be shipped from a fulfillment center, for example, based on the maximum available shipment quantity of the item in one or more fulfillment centers may ship within a specific period. When the item scrap occurs, the electronic apparatus according to the example embodiments determines whether a cause of scrapping an item is debadge based on a shipment status of items by period, a maximum available shipment quantity of one or more fulfillment centers, and a sales amount of items by period.

The electronic apparatus according to the example embodiments may confirm whether the sales status information of the item is the andon status in operation 1002. Specifically, the electronic apparatus may confirm the sales status information of the item within a period of a specific section when the item scrap occurs. When the electronic apparatus confirms that the sales status of the item within the period of the specific section is the andon status, the electronic apparatus may confirm the scrap cause due to the andon of the item in operation 1003. When the sales status of the item within the period of the specific section is not the andon status, the electronic apparatus may confirm other causes of scrap other than the scrap cause due to the andon of the item in operations 1004 to 1006.

For example, when the sales status of the item within the specific section is the andon status, and the andon status has continued for a specific period or the andon status continues to the present, the cause of scrapping the item may be determined as the scrap cause due to the andon. For example, when the sales status of the item is the andon status within the specific section, and the andon status continues longer than a code life of the item or the period from the date of the first occurrence of the andon status to the current date is longer than the code life of the item, the cause of scrapping the item may be determined as the scrap cause due to the andon.

The electronic apparatus according to the example embodiments may confirm whether shipment status information of an item is a debadge state in operation 1004. Specifically, the electronic apparatus may confirm the shipment status information of the item within the period of the specific section when the item scrap occurs. When the electronic apparatus confirms that the shipment status of the item within the period of the specific section is the debadge status, the electronic apparatus may confirm the scrap cause as the debadge of the item in operation 1005. When there is no debadge status of the item within the period of the specific section, the electronic apparatus may confirm other causes of scrap in operation 1006.

For example, when the sales status of the item within the specific section is the debadge status, and the debadge status has continued for the specific period or the debadge status continues to the present, the cause of scrapping the item may be determined as the scrap cause due to the debadge. For example, when the sales status of the item is the andon status within the specific section, and the andon status continues longer than a code life of the item or the period from the date of the first occurrence of the andon status to the current date is longer than the code life of the item, the scrap cause of the item may be determined as the scrap cause due to the andon.

The electronic apparatus according to the example embodiments may determine the scrap due to the debadge of the item based on the information indicating the sales amount of the item within a specific period and the maximum available shipment quantity of the item within the fulfillment center. For example, when a sales amount for a specific period is excessive within a specific period (for example, the specific period may also be checked in a unit of 1 day, 1 week, or 1 hour), and thus, exceeds the maximum available shipment quantity of the item within the specific period, the electronic apparatus may change the shipment status of the item from an active status to a debadge status. Accordingly, the electronic apparatus according to the example embodiments may confirm information indicating the shipment status of the item by period and sales pattern information indicating sales details of the items by period when the item scrap occurs. The electronic apparatus according to the example embodiments may confirm the shipment status by period to confirm the period for which the shipment status of the item is in the debadge state. The electronic apparatus may confirm the sales amount of the item for the period for which the shipment status of the item is in the debadge state and the maximum available shipment quantity of the item for the period for which the shipment status of the item is in the debadge state. The electronic apparatus may confirm the difference between the confirmed maximum available delivery quantity and the sales amount of the item, and when the confirmed difference is greater than or equal to a specific percentage (for example, 30%) of the scrap quantity of the entire item, may determine a cause of scrapping an item as the scrap due to the debadge of the item.

FIG. 11 is a diagram illustrating an example of a method of providing information related to item scrap corresponding to a scrap cause related to a forecast of a sales amount of an item according to example embodiments.

The method of providing information related to item scrap according to the example embodiments illustrated in FIG. 11 may be performed by the electronic apparatus according to the example embodiments. The electronic apparatus according to the example embodiments may perform some or all of the operations illustrated in FIG. 11. The electronic apparatus according to the example embodiments may perform some or all of operations 1100 to 1105 illustrated in FIG. 11. Referring to FIG. 11, the electronic apparatus according to the example embodiments may confirm item scrap in operation 1100. Operation 1100 of FIG. 11 may correspond to an operation of confirming item scrap of FIGS. 5 to 10.

When item scrap occurs, the electronic apparatus according to the example embodiments may confirm whether specific conditions are satisfied to confirm whether a cause of scrapping an item is a scrap cause related to a forecast of a sales amount of an item.

The electronic apparatus according to the example embodiments may confirm whether sales of an item tend to drop or increase, and when the sales of the item tend to drop, may determine the cause of scrapping the item as the scrap cause related to the forecast of the sales amount. That is, the cause of scrapping the item may be determined as the drop in sales amount of an item.

For example, the electronic apparatus according to the example embodiments may confirm each of a first maximum sales amount representing a maximum sales amount among daily sales quantities of an item for a first period, a second maximum sales amount representing a maximum sales amount among daily sales quantities of an item for a second period next to the first period, a first average sales amount representing an average sales amount of an item for the first period, and a second average sales amount representing an average sales amount of an item for the second period in operation 1101. According to example embodiments, the first period or the second period may be a period of various intervals such as 30 day intervals, 15 day intervals, 1 week intervals, 3 day intervals, and the like. The first maximum sales amount representing the maximum sales amount among the daily sales quantities of the item for the first period, the second maximum sales amount representing the maximum sales amount among the daily sales quantities of the item for the second period next to the first period, the first average sales amount representing the average sales amount of the item for the first period, and the second average sales amount representing the average sales amount of the item for the second period may be confirmed from, for example, the information on the item.

In this case, for example, the electronic apparatus may confirm whether the second maximum sales amount is smaller than or equal to a specific percentage of the first maximum sales amount and the second average sales amount is smaller than or equal to a specific percentage of the first average sales amount in operation 1102. When the second average sales amount is greater than the specific percentage of the first average sales amount, since it is not determined as a drop in sales amount, the electronic apparatus may confirm other causes of scrap other than the drop in sales amount in operation 1103. When the second average sales amount is smaller than or equal to the specific percentage of the first average sales amount, the electronic apparatus may determine the drop in sales amount as the cause of scrapping the item in operation 1104.

The electronic apparatus according to the example embodiments may determine the drop in sales amount of an item in various ways. For example, the electronic apparatus may calculate two periods to confirm a trend of a sales amount of an item, and confirm a reduction ratio by confirming an average sales amount and a maximum sales amount by day for the two periods, thereby confirming a reduction in a sales amount of an item. As another example, the electronic apparatus may confirm the drop in sales amount by confirming the average sales amount or the maximum sales amount, respectively, for a plurality of periods.

For example, the electronic apparatus according to the example embodiments may confirm an average sales amount or a maximum sales amount for a period having at least three equal intervals. The electronic apparatus according to the example embodiments may compare average sales quantities or maximum sales quantities for a specific period and a period immediately subsequent to the specific period to confirm whether the average sales amount or the maximum sales amount for the subsequent period is smaller than or equal to a specific percentage of the average sales amount or the maximum sales amount for the specific period. When it is confirmed whether the sales amount of the item drops by dividing all periods into two periods, the electronic apparatus according to the example embodiments may determine that the sales amount of the item drops.

For example, the electronic apparatus according to the example embodiments may confirm the average sales amount or the maximum sales amount for a period having at least three equal intervals. The electronic apparatus according to the example embodiments may compare average sales quantities or maximum sales quantities for a specific period and a period immediately subsequent to the specific period to confirm by period whether the average sales amount or the maximum sales amount for the subsequent period is smaller than the average sales amount or the maximum sales amount for the specific period by a specific quantity. When it is confirmed whether the sales amount of the item drops by dividing all periods into two periods, the electronic apparatus according to the example embodiments may determine that the sales amount of the item drops.

Further, when a cause of scrapping an item is confirmed as a scrap cause related to a forecast of a sales amount, the electronic apparatus according to the example embodiments may confirm whether the specific period is a promotion period of an item. When the specific period confirmed in the forecast of the sales amount is the promotion period of the item, the electronic apparatus according to the example embodiments may determine that the cause of scrapping the item is an over-estimated promotion which is a fifth scrap sub-cause in the scrap cause related to the forecast of the sales amount.

Furthermore, when the cause of scrapping the item is confirmed as the scrap cause related to the forecast of the sales amount, the electronic apparatus according to the example embodiments may confirm the scrap quantity of the scrapped item due to the scrap cause related to the forecast of the sales amount. The electronic apparatus may forecast a sales amount of a future item by adding or subtracting the confirmed scrap quantity of the item to the forecasted sales amount of the existing item by a specific percentage of the scrap quantity of the checked item, and determine an order quantity to be ordered to a supplier of an item by using the calculated sales amount of the future item.

With this configuration, the electronic apparatus according to the example embodiments may quickly confirm the item scrap based on the drop in sales amount. In addition, the electronic apparatus may calculate the drop in sales amount by specific period, and analyze the scrap cause and the scrap quantity, thereby accurately adjusting an order quantity of an item.

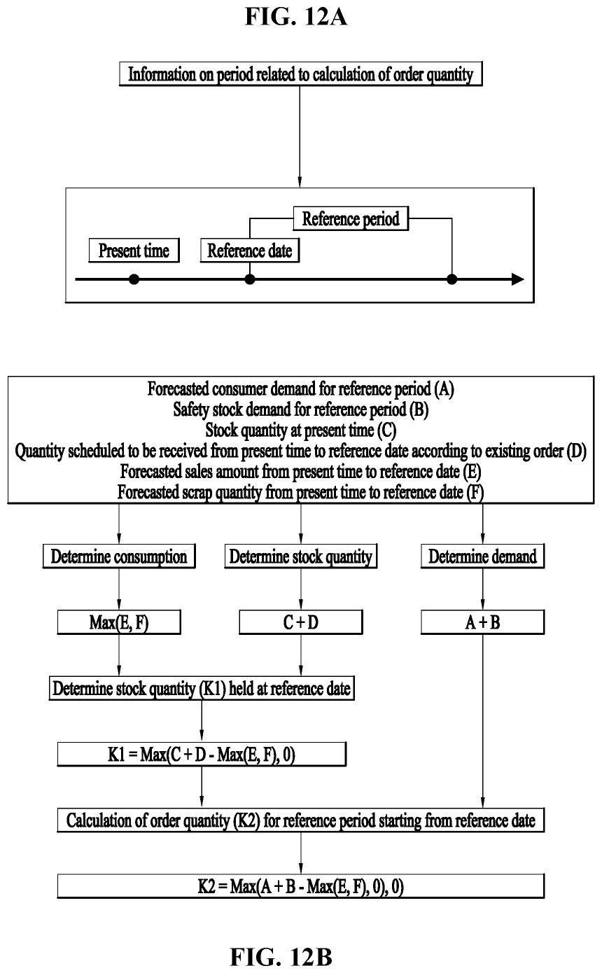

FIGS. 12A and 12B are diagrams illustrating an example of a process of calculating an order quantity for a reference period starting from a specific reference date at a present time by an electronic apparatus according to example embodiments.

The electronic apparatus according to the example embodiments may perform the same procedure as the flowchart illustrated in FIGS. 12A and 12B based on obtaining or determining various pieces of information (for example, information on items according to example embodiments) necessary for calculating an order quantity.

Referring to FIG. 12A, the electronic apparatus according to the example embodiments may acquire information on a period related to a calculation of the order quantity at the present time, and confirm a reference date for calculating the order quantity and a reference period starting from a reference date.

Referring to FIG. 12B, the electronic apparatus according to the example embodiments may acquire, confirm, or determine information on a forecasted consumer demand A for a reference period for calculating an order quantity, information on a safety stock demand B for a reference period, information on a current stock quantity C, information on a scheduled receiving quantity D from the current point to the reference date according to the existing order, information on a forecasted sales amount E from the present time to the reference date, and information on a forecasted scrap quantity F from the present time to the reference data.

In this case, in order to determine the consumption of the ordered item from the present time to the reference date, the larger value of the forecasted sales amount E or the forecasted scrap quantity F may be obtained. In this case, the use of the larger value of the forecasted sales amount and the forecasted scrap quantity may be to reflect that the ordered item is an item corresponding to a specific storage type. In other words, when the ordered item corresponds to the specific storage type, the shipment for sales of an item stored in a fulfillment center is made in the order of the saleable period or earliest expiration date, so the larger value of the forecasted sales amount and the forecasted scrap quantity may be determined as the consumption amount for the ordered item from the present time to the reference date.

In addition, in order to determine the stock quantity of the ordered item of the fulfillment center at the reference date, the sum of the current stock quantity C and the scheduled receiving quantity D according to the existing order may be obtained, and in order to determine the demand for the reference period, the sum of the forecasted consumer demand A and the safety stock demand B may be obtained.

In order to determine the forecasted stored stock quantity of the ordered item on the reference date, the electronic apparatus according to the example embodiments may obtain the larger value K1 of a value, which is obtained by subtracting the larger value of the forecasted sales amount E or the forecasted scrap quantity F from the sum of the current stock quantity C and the scheduled receiving quantity D according to the existing order, and 0. In this case, the use of the larger value of the subtracted value and 0 may be to reflect that the stored stock quantity forecasted at the reference date cannot be negative.

In order to calculate the order quantity for the reference period, the electronic apparatus according to the example embodiments may obtain the larger value K2 of a value obtained by subtracting the forecasted stored stock quantity from the sum of the forecasted consumer demand A and the safety stock demand B and 0. In this case, the use of the larger value of the subtracted value and 0 may be to reflect that the order quantity calculated for the reference period cannot be negative.

According to example embodiments, an equation for calculating an order quantity for a reference period starting from a specific reference date at the present time may be summarized as follows.

Order quantity=Max([forecasted consumer demand during reference period+safety stock demand for reference period−Max({stock quantity at present time+quantity scheduled to be received from present time to reference date according to existing order−Max (forecasted sales amount from current point to reference date, and forecasted scrap quantity from present time to reference date)},0)],0) [Equation 1]

In other words, the order quantity of the item according to example embodiments may be determined based on a value obtained by subtracting the maximum value of the forecasted scrap amount of the item and the minimum cost for the item within the specific period from the sum of the forecasted receiving amount of the item and the safety stock quantity of the item within the specific period. With the operation, the electronic apparatus according to the example embodiments suggests the method in which the electronic apparatus for providing information related to an order determines the stock quantity of the ordered item in the fulfillment center and consumption and demand for the ordered item, and provides the information on the order quantity calculated, thereby obtaining the technical effect of being capable of easily managing the order quantity of the ordered item.

FIG. 13 is a diagram illustrating an example of a method of providing information related to item scrap corresponding to a scrap cause due to overordering of an item.

The method of providing information related to item scrap according to example embodiments illustrated in FIG. 13 may be performed by the electronic apparatus according to the example embodiments. The electronic apparatus according to the example embodiments may perform some or all of the operations illustrated in FIG. 13. The electronic apparatus according to the example embodiments may perform some or all of operations 1300 to 1306 illustrated in FIG. 13. Referring to FIG. 13, the electronic apparatus according to the example embodiments may confirm item scrap in operation 1300. Operation 1300 of FIG. 13 may correspond to an operation of confirming item scrap of FIGS. 5 to 11.

When item scrap occurs, the electronic apparatus according to the example embodiments may confirm whether specific conditions are satisfied to confirm whether a cause of scrapping an item is a scrap cause related to a forecast of a sales amount of an item.

The electronic apparatus according to the example embodiments may confirm information indicating a code life of an item included in the item information and information indicating an average sales amount of the item in a specific period in operation 1301. The information indicating the code life of the item included in the information on the item, and the information indicating the average sales amount of the item for the specific period may be confirmed from the information on the item according to the example embodiments.

The electronic apparatus according to the example embodiments may confirm an order quantity of an item in operation 1303. That is, the electronic apparatus may confirm an order quantity of a specific order in an item received in a fulfillment center by a specific order.

The electronic apparatus according to the example embodiments may compare the order quantity of the item with the actual sales amount of the item, and check whether the item scrap has occurred due to overordering of an item to a supplier.

For example, the electronic apparatus according to the example embodiments may confirm whether the above-described order quantity is greater than the product of the code life and the average sales amount in operation 1303. That is, the electronic apparatus may confirm how many items have been sold for the period for which the item may be actually sold and may confirm whether the confirmed sales quantity is actually smaller than the order quantity.

When the order quantity is smaller than or equal to the product of the code life and the average sales amount, since the item scrap does not occur due to the overordering, the electronic apparatus according to the example embodiments may confirm other causes of scrap in operation 1304. Meanwhile, when the order quantity is greater than the product of the code life and the average sales amount, the electronic apparatus according to the example embodiments may determine the overordering as the cause of scrapping the item in operation 1305.

When the cause of scrapping the item is determined as the overordering, the electronic apparatus according to the example embodiments may adjust the order quantity of the item to prevent overordering of the item. For example, the electronic apparatus according to the example embodiments may readjust the amount of safety stock demand according to the example embodiments of the item in operation 1306.

For example, the electronic apparatus according to the example embodiments may first confirm the code life of the item or the period for which the item is received from a supplier. The electronic apparatus may determine the safety stock demand of the item in proportion to the code life or the safety stock demand of the item. Furthermore, when the item scrap occurs based on the overordering in operation 1305, the electronic apparatus may confirm the difference between the sales amount and the order quantity of the item for the specific period (for example, an code life or an item receiving period) of the actual item, calculate the confirmed difference and the percentage of the order quantity of the item, and then subtract the safety stock demand by the calculated percentage, thereby adjusting the safety stock demand.

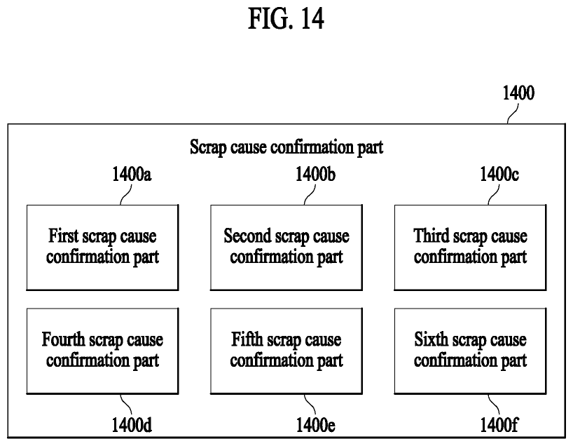

FIG. 14 is a diagram illustrating another example of internal components of an electronic apparatus according to example embodiments.

The electronic apparatus according to the example embodiments illustrated in FIG. 14 may refer to the electronic apparatus according to the example embodiments described with reference to FIGS. 1 to 13. The electronic apparatus according to the example embodiments may include at least one of a first scrap cause confirmation part 1400a, a second scrap cause confirmation part 1400b, a third scrap cause confirmation part 1400c, a fourth scrap cause confirmation part 1400d, and a fifth scrap cause confirmation part 1400f. The first scrap cause confirmation part to the sixth scrap cause confirmation part 1400f may determine one or more of the first cause of scrapping an item to the sixth scrap cause according to example embodiments based on each logic of the cause of scrapping the item in response to confirming the scrap of the item.

The first scrap cause according to example embodiments may include the scrap cause due to the minimum order quantity in FIG. 3, and the scrap cause corresponding to the designed scrap and the scrap cause corresponding to the large MOQ in FIG. 4. The first scrap cause confirmation part 1400a according to the example embodiments may perform the operation illustrated in FIG. 5 to confirm whether the cause of scrapping the item is the first scrap cause according to the example embodiments.

The second scrap cause according to the example embodiments may include the scrap cause due to the defect in the fulfillment center of FIG. 3, and may include causes of scrap due to the receiving delay, the cross dock receiving delay, the stowing delay, the cross dock stowing delay, the loss during the stowing, or the scrap cause due to the loss during the stowing in the cross dock. The second scrap cause confirmation part 1400b according to the example embodiments may perform some or all of the operations illustrated in FIGS. 6 to 9, for example, to confirm whether the cause of scrapping the item is the second scrap cause according to the example embodiments.

The third scrap cause according to the example embodiments may include the scrap cause due to the andon of the item in FIG. 3, and the scrap cause due to the andon may be included among the causes of scrap corresponding to the abnormal cause in FIG. 4. The third scrap cause confirmation part 1400c according to the example embodiments may perform the operations illustrated in FIG. 10 to confirm whether the cause of scrapping the item is the third scrap cause according to the example embodiments.

The fourth scrap cause according to the example embodiments may include the scrap cause due to the debadge of the item in FIG. 3, and the scrap cause due to the debadge may be included among the causes of scrap corresponding to the abnormal cause in FIG. 4. The fourth scrap cause confirmation part 1400d according to the example embodiments may perform the operations illustrated in FIG. 10 to confirm whether the cause of scrapping the item is the fourth scrap cause according to the example embodiments.

The fifth scrap cause according to the example embodiments may include the scrap cause related to the forecast of the sales amount of the item in FIG. 3 and include the scrap cause corresponding to the forecast, the scrap cause due to the drop in the sales amount, the scrap cause due to the over-estimated promotion, and the scrap cause due to the over estimation in FIG. 4. The fifth scrap cause confirmation part 1400e according to the example embodiments may perform the operations illustrated in FIG. 11 to confirm whether the cause of scrapping the item is the fifth scrap cause according to the example embodiments.

The sixth scrap cause according to the example embodiments may include the scrap cause due to the overordering of the item in FIG. 3, and include the scrap cause according to the overordering in FIG. 4. The sixth scrap cause confirmation part 1400f according to the example embodiments may perform, for example, the operations illustrated in FIGS. 12A, 12B, and 13 to confirm whether the cause of scrapping the item is the sixth scrap cause according to the example embodiments.

The electronic apparatus according to the example embodiments may confirm the cause of scrapping the item in the order of confirming the scrap cause determined based on the priority of the first scrap cause to the sixth scrap cause according to the example embodiments. That is, the electronic apparatus according to the example embodiments may combine the first to sixth scrap cause confirmation parts 1400a to 1400f according to the example embodiments in a specific order so that the cause of scrapping the item may be understood in the order of confirming the scrap cause. The first to sixth scrap cause confirmation parts 1400a to 1400f according to the example embodiments may confirm the cause of scrapping the item based on the information on the item according to the example embodiments. The information on the item may include, for example, the code life of the item and the average sales amount of the item by period. The information on the item may further include the minimum order quantity corresponding to the item, the unloading completion time of the item within the fulfillment center, the scheduled receiving time of the item, the unloading amount of the item, the confirmed quantity of the item, the unloading amount of the item and the stowing amount of the item within the fulfillment center, and the maximum sales amount among the daily sales amounts of the item for the specific period, and the average sales amount indicating the average sales amount of the item for the specific period. That is, the electronic apparatus according to the example embodiments may confirm the cause of scrapping the item in the order of confirming the scrap cause determined based on the priority of the first scrap cause to the sixth scrap cause according to the example embodiments.

The electronic apparatus according to the example embodiments may carefully analyze the scrap cause by combining the methods for analyzing various causes of scrap in a specific order or a preset order and confirming the causes of scrap according to the priority, thereby preventing the item from being scrapped in the future.

Meanwhile, the example embodiment of the present disclosure has been disclosed in the present specification and drawings, and although specific terms are used, these are merely used in a general sense to easily describe the technical content of the present disclosure and to aid understanding of the present disclosure but is not intended to limit the scope of the present disclosure. It is obvious to those of ordinary skill in the art to which the present disclosure pertains that other modifications based on the technical idea of the present disclosure may be implemented in addition to the example embodiments disclosed herein.

The electronic apparatus or terminal according to the above-described example embodiments may include a processor, a memory that stores and executes program data, a permanent storage such as a disk drive, a communication port that communicates with an external device, a touch panel, a key, a user interface device such as a button, and the like. Methods implemented as software modules or algorithms may be stored on a computer-readable recording medium as computer-readable code or program instructions executable on the processor. Here, examples of the computer-readable recording medium may include magnetic storage media (for example, a read-only memory (ROM), a random-access memory (RAM), a floppy disk, a hard disk, etc.), optical reading media (for example, a compact disk (CD)-ROM or a digital versatile disc (DVD)), and the like. The computer-readable recording medium may be distributed in computer systems connected to each other through a network, and as a result, the computer-readable code may be stored and executed in a distributed manner. The medium may be readable by a computer, stored in a memory, and executed on a processor.

The present example embodiment may be represented by functional block configurations and various processing operations. These functional blocks may be implemented by various numbers of hardware and/or software components that execute specific functions. For example, the example embodiment may employ integrated circuit configurations, such as a memory, processing, logic, and a look-up table, capable of executing various functions by control of one or more microprocessors or other control devices. Similar to executing the components with software programming or software elements, the present example embodiment may be implemented with programming or scripting languages such as C, C++, Java, Assembly, and Python including various algorithms implemented by a combination of data structures, processes, routines or other programming configurations. Functional aspects may be implemented with algorithms executed on one or more processors. In addition, the present example embodiment may employ a conventional technology for electronic environment setting, signal processing, and/or data processing, and the like. Terms such as “mechanism,” “element,” “means,” and “configuration” may be used broadly and are not limited to mechanical and physical configurations. The terms may include the meaning of a series of routines of software in connection with a processor or the like.

The above-described example embodiments are merely examples, and other example embodiments may be implemented within the scope of the following claims.

Meanwhile, the example embodiments of the present disclosure have been disclosed in the present specification and drawings, and although specific terms are used, these are merely used in a general sense to easily describe the technical content of the present disclosure and to aid understanding of the present disclosure but is not intended to limit the scope of the present disclosure. It is obvious to those of ordinary skill in the art to which the present disclosure pertains that other modifications based on the technical idea of the present disclosure may be implemented in addition to the example embodiments disclosed herein.

What is claimed is:

1. A method of providing information related to item scrap by an electronic apparatus, the method comprising:
confirming information on an item scrapped in a fulfillment center, the information on the item including a code life of the item and an average sales amount of the item;
confirming a cause of scrapping the item based on the information on the item; and
providing information indicating the cause of scrapping the item.

2. The method of claim 1, wherein the cause of scrapping the item includes at least one of a first scrap cause related to a minimum order quantity of the item, a second scrap cause related to the fulfillment center, a third scrap cause related to a sales status of the item, a fourth scrap cause related to a shipment status of the item, a fifth scrap cause based on a forecast error of a sales amount of the item, and a sixth scrap cause based on overordering of the item.

3. The method of claim 2, wherein the confirming of the cause of scrapping the item comprises confirming the cause of scrapping the item in an order of confirming a scrap cause determined based on a priority of the first scrap cause to the sixth scrap cause.

4. The method of claim 2, wherein the information on the item further includes a minimum order quantity corresponding to the item, and
the confirming of the scrap cause comprises determining the cause of scrapping the item when the minimum order quantity is greater than a product of the code life of the item and the average sales amount of the item for the code life.

5. The method of claim 4, further comprising:
when the cause of scrapping the item is the first scrap cause,
confirming a first average sales amount of the item for a first period and a second average sales amount indicating the average sales amount of the item for a second period next to the first period based on the average sales amount of the item; and
calculating an appropriate minimum order quantity corresponding to the item based on the first average sales amount and the second average sales amount when the second average sales amount is smaller than or equal to the first average sales amount.

6. The method of claim 5, wherein when the second average sales amount is greater than the first average sales amount, an exposure priority of the item increases.

7. The method of claim 5, wherein when the second average sales amount is greater than the first average sales amount, the item is exposed on a main page.

8. The method of claim 2, wherein the second scrap cause includes a first scrap sub-cause related to a receiving delay of the item, a second scrap sub-cause related to a stowing delay of the item, and a third scrap sub-cause related to loss of the item.

9. The method of claim 8, wherein the information on the item includes a unloading completion time of the item in the fulfillment center, a scheduled receiving time of the item, an unloading amount of the item, and a confirmed quantity of the item, and
the method further comprises determining the cause of scrapping the item as the first scrap sub-cause of the second scrap cause when the unloading amount of the item is greater than or equal to a specific percentage of the confirmed quantity and a difference between the unloading completion time of the item and the scheduled receiving time of the item is a specific time or more.

10. The method of claim 2, wherein the information on the item includes an unloading amount of the item and a stowing quantity of the item in the fulfillment center, and
the method further comprises determining the cause of scrapping the item as a second scrap sub-cause when the unloading amount of the item is greater than the stowing quantity of the item and a difference between a stowing completion time of the item and an unloading completion time of the item is a specific time or more.

11. The method of claim 10, wherein when a difference between a time when the item is scrapped and a time when the scrapped item is received is the specific time or more, the determining of the scrap cause comprises determining the cause of scrapping the item as a third scrap sub-cause.

12. The method of claim 11, wherein the information on the item includes a first maximum sales amount indicating a maximum sales amount among daily sales amounts of the item for a first period, a second maximum sales amount indicating a maximum sales amount among daily sales amounts of the item for a second period next to the first period, a first average sales amount indicating an average sales amount of the item for the first period, and a second average sales amount indicating an average sales amount of the item for the second period, and
the determining of the scrap cause further comprises determining the cause of scrapping the item as the fifth scrap cause when the second maximum sales amount is smaller than or equal to a specific percentage of the first maximum sales amount and the second average sales amount is smaller than or equal to a specific percentage of the first average sales amount.

13. The method of claim 12, wherein the determining of the scrap cause further comprises:
confirming an order quantity of the item; and
determining the cause of scrapping the item as the sixth scrap cause when the order quantity is greater than a product of the code life of the item and the average sales amount of the item for the code life.

14. The method of claim 13, wherein the order quantity is determined based on a value obtained by subtracting a maximum value of a forecasted scrap quantity of the item and a minimum cost for the item within a specific period from a sum of a forecasted receiving quantity of the item and a safety stock quantity of the item within the specific period.

15. The method of claim 14, further comprising:
reducing the safety stock quantity of the item based on the code life and the average sales amount when the cause of scrapping the item is the sixth scrap cause.

16. The method of claim 2, wherein the confirming of the cause of scrapping the item comprises confirming the cause of scrapping the item based on a decision tree for determining the scrap cause based on the information on the item.

17. The method of claim 1, further comprising:
reporting scrap information including the cause of scrapping the item.

18. The method of claim 17, wherein the reporting comprises reporting the information indicating the cause of scrapping the item to a subject corresponding to the confirmed cause of scrapping the item.

19. An electronic apparatus for providing information related to item scrap, the electronic apparatus comprising:
a memory in which at least one program is stored; and
a processor configured to confirm information on an item scrapped in a fulfillment center, confirm a cause of scrapping the item based on the information on the item, and provide information indicating the cause of scrapping the item.

20. A non-transitory computer-readable storage medium comprising a medium configured to store computer-readable instructions,
wherein when the computer-readable instructions are executed by a processor, the processor is configured to perform:
confirming information on an item scrapped in a fulfillment center;
confirming a cause of scrapping the item based on the information on the item; and
providing information indicating the cause of scrapping the item.
